(19) United States
(12) Patent Application Publication
(10) Pub. No.: US 2016/0225005 A1
(43) Pub. Date: Aug. 4, 2016

(54) PEOPLE ENGAGEMENT AND REDEMPTION SYSTEM

(71) Applicant: Sanjiv ARORA, New Delhi (IN)

(72) Inventor: Sanjiv ARORA, New Delhi (IN)

(21) Appl. No.: 15/014,270

(22) Filed: Feb. 3, 2016

(30) Foreign Application Priority Data
Feb. 3, 2015 (IN) 314/DEL/2015

(51) Int. Cl. G06Q 30/02

(52) U.S. Cl. CPC G06Q 30/0217; G06Q 30/0233; G06Q 30/0245; G06Q 30/0277

(57) ABSTRACT

A method of communication with a user includes initiating a campaign which in turn includes sending a series of communications to the user. Further, the method awards at least one credit to the user for each response received from the user relating to the series of communication, maintains a credit balance of the awarded at least one credit in a database and allows the user to redeem a quantity of credits from the credit balance on successfully responding to at least one of one or more conditions, the one or more conditions correspond to the campaign.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

This invention relates to systems and methods for online communication systems, specifically, the present disclosure relates to communication system and methods for rewarding credits based upon user engagement.

2. Description of Related Art Including Information Disclosed Under 37 CFR 1.97 and 37 CFR 1.98.

It is important for any organization to keep its employees engaged and well-aware about its product/service offerings. More so because the employees are the best marketing tools of an organization. To meet this end, organizations conduct regular campaigns be it online or offline to educate their employees.

Other than employees, clients of an organization contribute to the word of mouth publicity through one-to-one interactions, social platforms. This is another source which, if tapped correctly, can result in business for an organization.

There is thus a need for a system and method to positively engage the employees, customers, etc of an organization to make them more connected and aware about an organization's offerings, policies, administration, etc.

### BRIEF SUMMARY OF THE INVENTION

The following summary is provided to facilitate an understanding of some of the innovative features unique to the disclosed embodiments and is not intended to be a full description. A full appreciation of the various aspects of the embodiments disclosed herein can be gained by taking into consideration the entire specification, claims, drawings, and abstract as a whole.

A method of communication with a user is provided. The method includes initiating a campaign which in turn includes sending a series of communications to the user. Further, the method awards at least one credit to the user for each response received from the user relating to the series of communication, maintains a credit balance of the awarded at least one credit in a database and allows the user to redeem a quantity of credits from the credit balance on successfully responding to at least one of one or more conditions, the one or more conditions correspond to the campaign.

A system for communication with a user is disclosed. The system includes a web server which is configured to initiate a campaign which in turn includes sending a series of communications to the user. Further, the web server awards at least one credit to the user for each response received from the user relating to the series of communication, maintains a credit balance of the awarded at least one credit in a database and allows the user to redeem a quantity of credits from the credit balance on successfully responding to at least one of one or more conditions, the one or more conditions correspond to the campaign.

Other aspects and advantages of the invention will become apparent from the following detailed description, taken in conjunction with the accompanying drawings, illustrating by way of examples the principles of the invention.

### BRIEF DESCRIPTION OF THE SEVERAL VIEWS OF THE DRAWINGS

FIG. 1 is a schematic diagram of a system according to one embodiment of the invention.

FIG. 2 is a schematic diagram of a credit redemption system according to one embodiment of the invention.

FIGS. 3, 4, and 5 are flow diagrams illustrating a number of steps carried out by a server in FIG. 1.

### DETAILED DESCRIPTION OF THE INVENTION

Methods and systems for multi-way communications are disclosed. The following description is presented to enable any person skilled in the art to make and use the invention. For purposes of explanation, specific nomenclature is set forth to provide a thorough understanding of the present invention. Descriptions of specific applications are provided only as examples. Various modifications to the preferred embodiments will be readily apparent to those skilled in the art, and the general principles defined herein may be applied to other embodiments and applications without departing from the spirit and scope of the invention. Thus, the present invention is not intended to be limited to the embodiments shown, but is to be accorded the widest scope consistent with the principles and features disclosed herein.

Applications, software programs or computer readable instructions may be referred to as components or modules. Applications may be hardwired or hard coded in hardware or take the form of software executing on a general purpose computer such that when the software is loaded into and/or executed by the computer, the computer becomes an apparatus for practicing the invention, or they are available via a web service. Applications may also be downloaded in whole or in part through the use of a software development kit or a toolkit that enables the creation and implementation of the present invention. In this specification, these implementations, or any other form that the invention may take, may be referred to as techniques. In general, the order of the steps of disclosed processes may be altered within the scope of the invention.

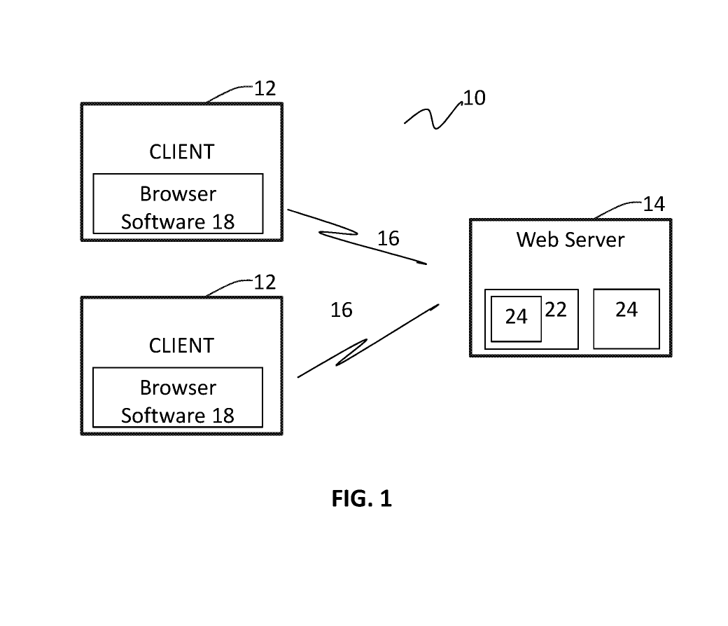

Referring now to the drawings, FIG. 1 is an example of a distributed system 10 configured as client/server architecture used in an embodiment of the present invention. A “client” is a member of a class or group that uses the services of another class or group to which it is not related. In the context of a computer network, such as the Internet, a client is a process (i.e. roughly a program or task) that requests a service which is provided by another process, known as a server program. The client process uses the requested service without having to know any working details about the server program or the server itself. In networked systems, a client process usually runs on a computer that accesses shared network resources provided by another computer running a corresponding server process. However, it should also be noted that it is possible for the client process and the server process to run on the same computer.

A “server” is typically a remote computer system that is accessible over a communications medium such as the Internet. The client process may be active on a second computer system, and communicate with the server process over a communications medium that allows multiple clients to take advantage of the information-gathering capabilities of the server. Thus, the server essentially acts as an information provider for a computer network.

The block diagram of FIG. 1 therefore shows a distributed system 10 that includes a plurality of client computers 12 and a web server 14 which are connected to a network 16. The network 16 will be hereinafter generally referred to as the Internet. Although the system and method of the present invention is specifically useful for the Internet, it should be understood that the client computers 12 and web server 14 may be connected together through one of a number of different types of networks. Such networks may include local area networks (LANs), other wide area networks (WANs), and regional networks accessed over telephone lines, such as commercial information services. The client and server processes may even comprise different programs executing simultaneously on a single computer.

The client computers 12 can be conventional personal computers (PCs), workstations, mobile phones, smartphones, or computer systems of any other size. Each client computer 12 may include one or more processors, memories, input/output devices, and a network interface, such as a conventional modem, a wireless receiver, etc. The web server 14 can be similarly configured.

A display on the client computer 12 enables a user to interact with a web application via a user interface displayed on the computer 12. For purposes of the preferred embodiment, it is assumed that the display is used to present information to each user, but it should be understood that information may be presented to a user by an audio signal, a Braille interface or any other suitable user interface.

The client computers 12 can execute web browser programs 18, such as the NAVIGATOR, EXPLORER, or FIREFOX browser programs, to locate the web pages or records stored on the web server 14. The browser programs 18 allow the users to enter addresses of specific web pages to be retrieved. These addresses are referred to as Uniform Resource Locators, or URLs. In addition, once a page has been retrieved, the browser programs 18 can provide access to other pages or records when the user “clicks” on hyperlinks or other elements on the web page. Such hyperlinks/elements are located within the web pages and provide an automated way for the user to enter the URL of another page and to retrieve that page. The pages can be data records including plain textual information, or more complex digitally encoded multimedia content, such as software programs, graphics, audio signals, videos, and so forth.

In an embodiment of the present invention, shown in FIG. 1, client computers 12 communicate through the network 16 with various network information providers, including web server 14 using the functionality provided by a HyperText Transfer Protocol (HTTP), although other communications protocols, such as File Transfer Protocol (FTP), Simple Network Management Protocol (SNMP), TELNET, and a number of other protocols known in the art, may be used. The web server 14 is located on the World Wide Web.

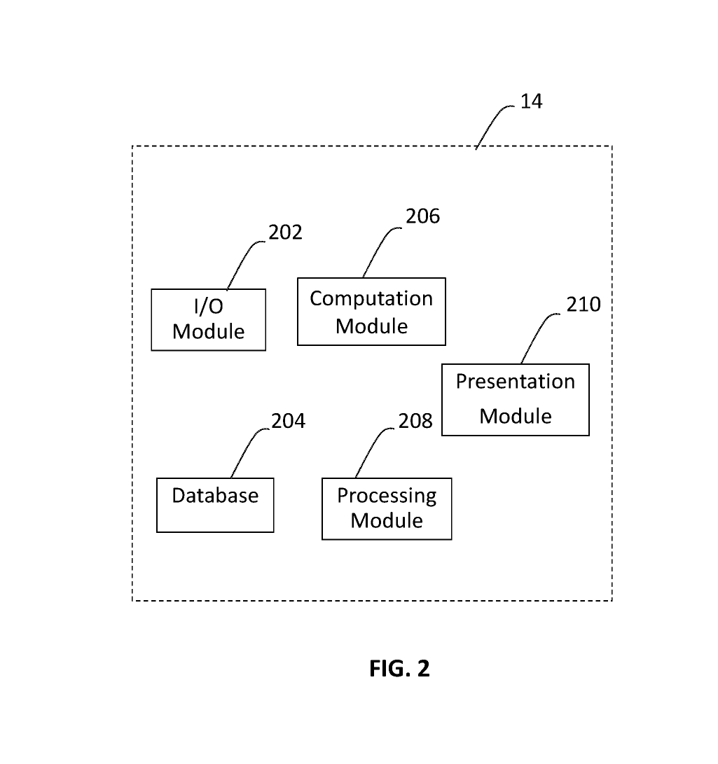

The web server 14 hosts the website of an individual/entity. The web server 14 includes a computer storage medium 22 and a processing system 24. A database 26 is stored on the storage medium 22 of the web server 14. The database 26 contains data relating to one or more web pages, one or more campaigns, a lookup table of the mappings, account information including without limitation, name of the account holder, age, profession, designation, address, and a variety of information, described below. It will be appreciated from the description below that the system and method of the present disclosure may be implemented in software that is stored as executable instructions on a computer storage medium, such as memories or mass storage devices, on the web server 14. Conventional browser programs 18, running on client computers 12, may be used to access account information stored on the web server 14. In an embodiment, access to the web server 14 is accomplished through a firewall, not shown, which protects the account management and one or more campaigns and the account information from external tampering. Additional security may be provided via enhancements to the standard communications protocols such as Secure HTTP or the Secure Sockets Layer. A web server 14 may refer to the web server of an entity/individual wanting to advertise, educate, promote, etc its products/services. The modules (described in FIG. 2) on the web server 14 perform various functions without limitation, awarding credits, computing credits accorded to a user and allowing or rejecting redemption of credits on successfully meeting a predefined condition.

FIG. 2 illustrates an exemplary block diagram of the web server 14 that is configured as a credit redemption system. The web server 14 includes an input-output module 202, a database 204, a computation module 206, a processing module 208 and a presentation module 210. As stated above, the web server 14 is connected to the network 16, for example, Internet via which it can be accessed by one or more client computers 12.

The input-output module 202 is configured to receive a request from the client computer 12. Additionally, the input-output module 202 is configured to respond to the received request by transmitting data, for example, web page data, application data, information packets containing a communication, etc to the requesting client computer 12. The response may include for example, information about a product/service, company policy, new promotional schemes, awareness programs, etc.

The database 204 stores one or more conditions that correspond to a campaign. A campaign may be a theme or a topic relating to which for example, awareness is to be spread, user engagement is sought, etc. Each campaign consists of a plurality of communications to be sent to a user. Exemplary communications includes questions on various facet of a topic, audio notes, policy documents, etc. In case a communication is a multiple choice question, a look-up table with one or more mappings of a correct answer to the question is stored. Further, the database 204 stores the number of credits to be awarded for each communication. These mappings may be vary as per the website owner's preference. Other than communications, for each campaign, one or more conditions are framed that act as a secret question at the time of credit redemption and are stored in the database 204 mapped to the title of the campaign. The database 204 also includes one or more records of account information including without limitation, name of the account holder, age, profession, designation, address, place of work, etc. In addition, the database 204 stores credit balance of a user, credits redeemed, etc. In an embodiment, the information is encrypted to maintain confidentiality and/or privacy of users.

The computation module 206 is configured to perform one or more computations relating to the number of credits secured by a user, accuracy of a user's response, possibility of credit redemption, etc. In an embodiment, the computation module 206 receives a user response and awards one or more credits if the response is correct after referring to the look-up table stored in the database 204. Alternately, the computation module 206 monitors an action taken by a user for example, viewing a web page, listening to an audio note, etc. before awarding one or more credits to the user. Additionally and optionally, the computation module 206 is provided with an algorithm that awards one or more credits to a user based upon the quality of inputs provided. For example, the quality can be judged based upon the length of a user response, presence of certain key terms, absence of certain key terms, etc. The computation module 206 also determines if the number of credits awarded to a user have crossed a predefined number and can be redeemed.

The processing module 208 co-ordinates the functioning of each module and is responsible for the functioning of the web server 14. It communicates with the input-output module 202 to receive a user's query and obtains relevant data from the database 204. The processing module 208 may either fetch the requested web page from the database 204 to the input-output module 202 or communicate with the computation module 206, provide it the data obtained from the database 204 and forward the computed credits/response to the presentation module 210. Further, the processing module 210 directs the input-output module 202 to transmit the credits/response to the user.

The presentation module 210 collates the credits/response and prepares a list in a predefined format, for example, pdf, a word document, a spreadsheet, etc to be presented to a user.

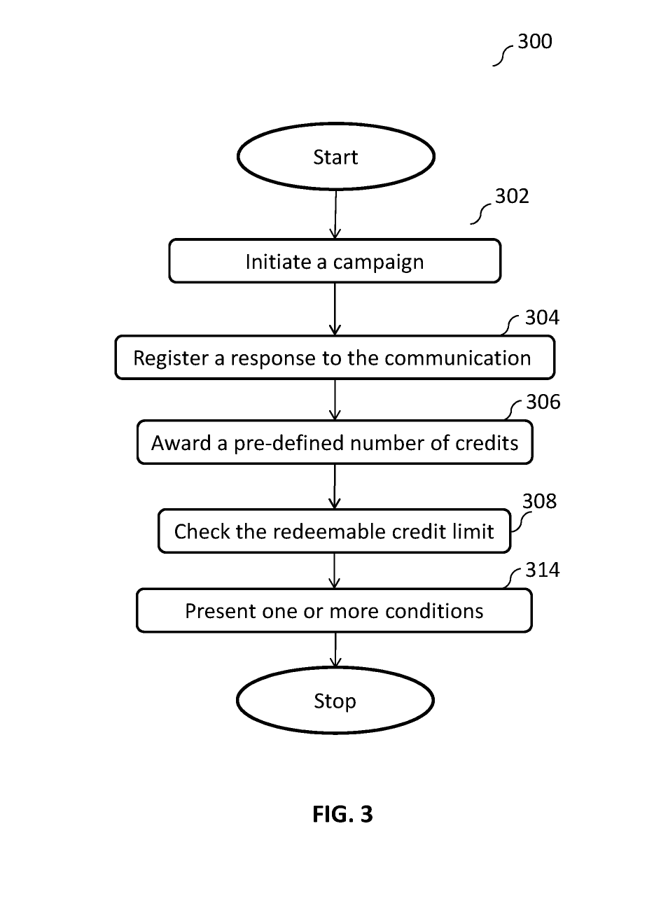

FIG. 3 depicts an exemplary flowchart 300 for the first embodiment of the present disclosure. At step 302, the credit redemption system hosted on the web server 14 initiates a campaign suggested by a sponsor. To initiate the campaign, one or more communications for example, PUSH messages are delivered to the client 12. The client may be a mobile phone whose Mobile Station International Subscriber Directory Number (MSISDN) and/or other information (for example, sex, age, etc) is registered with the web server 14. The messages may be text, audio, audio visual, video etc. In an embodiment, a message relating to the campaign is selected by the web server 14 based upon one or more parameters like category of message, age slab, sex, state, specific time(s) of day ie, start hrs-end hrs, a date range (from and to date), message frequency, hourly, 2 hourly, etc. This selection may be auto-configured or configured by an organization/individual. A communication may be in the form of multiple choice questions with predefined options like good, average, not good and not used or the questions may be descriptive type. In an embodiment, when a message is sent to the client 12, the corporate product image, logo, etc is displayed as sponsors to increase a product or client visibility.

At step 304, a response to the communication is received. The response may be any related action taken by the client including without limitation, viewing a website, selecting an option from predefined options, providing a detailed response, playing an audio note, etc. In some cases for example, if the client selects average or not good, the user of the client may be requested to provide a feedback. The user may provide feedback by either selecting one of the predefined options provided or input his/her feedback. Alternately, the user may first view the website of the company to gain more information about the product/company and thereafter, respond to the communication. It should be understood that this is merely one aspect of the invention, and that many other options exist for predetermined conditions.

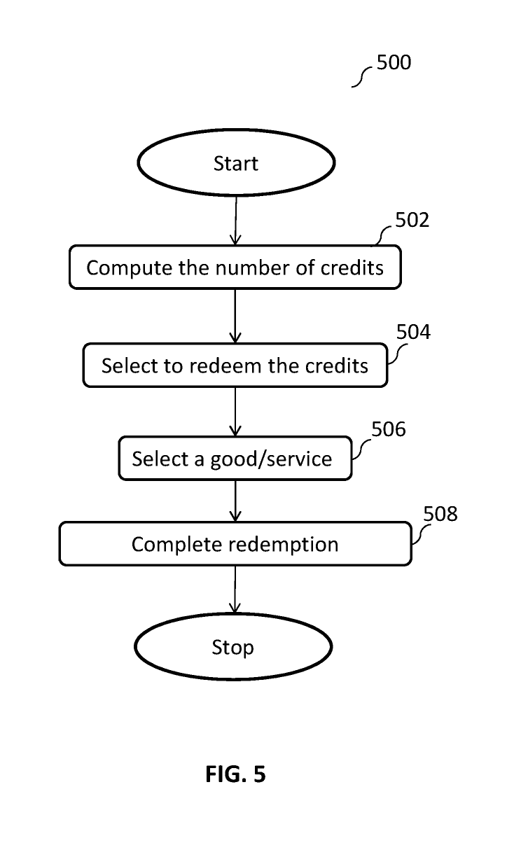

At step 306, the web server 14 awards predefined number of credits to the user based upon the response received. In various embodiments, the web server 14 awards the user credits using the lookup table maintained in the database 204. The credits are added to the tally of previous credits of the user, if any and thus, a credit balance for the respective user is maintained. At step 308, a check is made if the number of credits equals to or exceeds the redeemable credit limit. If yes, in an embodiment, a message may be sent to the user. At step 310, if the user selects to redeem the credits, one or more conditions related to the campaign are posed to the user. Such conditions are retrieved from the database 204 and presented to the user. In an embodiment, the one or more conditions relate to the campaign which the user had participated in. If the user correctly responds to the same, redemption is allowed. In an embodiment, if the user has reached redemption level for the first time, he/she is not evaluated and this step is skipped. This is done to encourage user to become active and promote the credit redemption system. Alternatively, the user has the option of redeeming credits later and saving the balance of earned credits for future use till until the message campaign is running. Details of redemption process are described in FIG. 5.

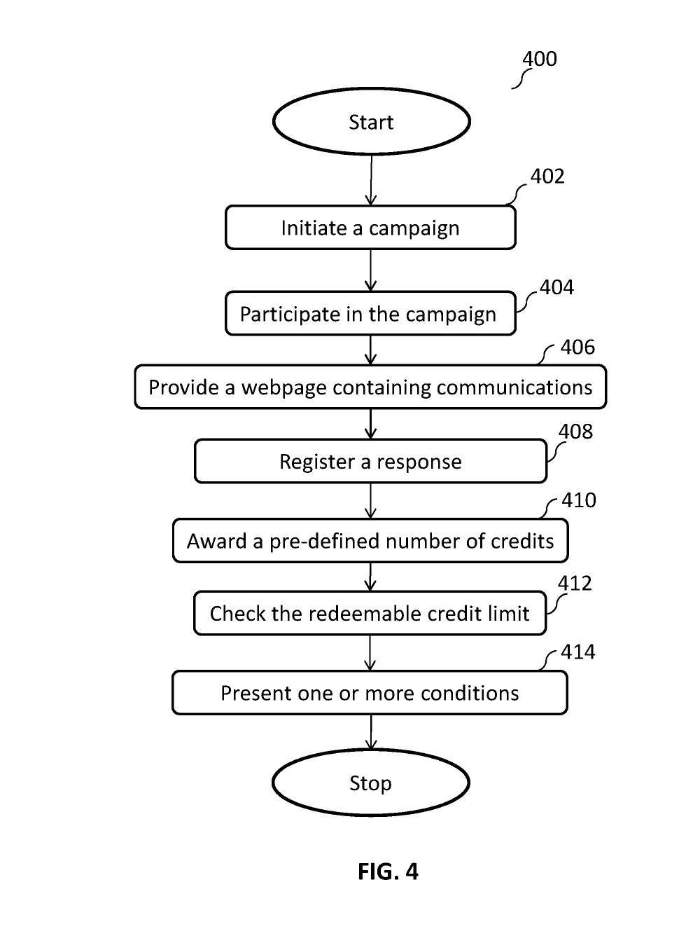

FIG. 4 depicts an exemplary flowchart 400 for the second embodiment of the present disclosure. At step 402, a campaign is initiated by the web server by triggering an email to a user. Upon receiving the email, the user accesses the website of the individual/entity hosted on the web server 14 through the network 16. In an exemplary embodiment, this is done by issuing appropriate commands through an associated user interface, which transmits the commands to the associated ISP, which in turn, transmits the command to the appropriate web server 14 through the network 16 and the web server's ISP. The formatting required to transmit the instructions to the correct ISP is done using standard protocols and is well known to those skilled in the art. In another embodiment of the present invention, an alternate user interface and an alternative service delivery network such as a telephone and a long distance telephone service provider, a television and a cable or satellite transmission system, or any other compatible pairing of service interface and delivery network systems suited to delivery of the service for which credits are redeemed may be used.

The user accesses the home page of the website by typing in the URL of the webpage. In various embodiments, the user may access the website directly or by logging in. If the user is a registered member, the user enters a user name and a password. If the user is not a registered member, he or she may register with the website before continuing. For registration, the user may be required to enter information regarding his identity, address, age, contact information, a user name, a password, etc. On successful registration/logging in, the user may select to participate in a campaign run by the website owner at step 404. In an embodiment, the user may search for the campaign using a search option provided on the web page. A campaign may be a series of communications by the product/service owner to promote, advertise, spread awareness, promote education, etc about the product/service. The registered user is allowed to instantaneously view the results of the campaigns to validate and take advantage of the effectiveness, reach, quality and volumes of the campaigns.

At step 406, the credit redemption system provides the user a webpage containing one or more communications, for example, questions. The questions may be multiple choice questions with predefined options like good, average, not good and not used or the questions may be descriptive type. At step 408, the credit redemption system receives the user response to the communication. In some cases for example, if the user selects average or not good, the web server 14 requests a feedback from the user. The user may provide feedback by either selecting one of the predefined options or input his/her feedback.

At step 410, the web server 14 awards credits to the user if the previous step is successful. The credits are added to the tally of previous credits of the user, if any. In various embodiments, the user earns credits on viewing of company/product web page, company advertisements (ads), etc and/or by providing feedback. At step 412, a check is made if the number of credits equals to or exceeds the redeemable credit limit. If yes, a pop up message is displayed to the user. At step 414, if the user selects to redeem the credits, one or more conditions related to the campaign is posed to the user. If the user correctly responds to the same, redemption is allowed. In an embodiment, if the user has reached redemption level for the first time, he/she is not evaluated and this step is skipped. This is done to encourage user to become active and promote the credit redemption system. Alternatively, the user has the option of redeeming credits, or leaving the website and saving the balance of earned credits for future use till until the message campaign is running.

In either of the embodiments depicted in FIGS. 3 and 4, the response of the user may be immediately presented to the user, sponsor, web hosting entity, etc. Further, a range of analytics like running a vote-count, percentage of ‘good’ response, feedbacks, etc can be tracked and instantaneously displayed. It will be evident to a person skilled in the art that such features/analysis forms a part of the invention.

FIG. 5 illustrates an exemplary credit redemption process 500. As discussed above, once the user has earned credits such that his account reflects a positive balance of credits, the user can redeem any or all of the balance of credits. Various embodiments of this invention encompass different goods and services for which credits may be redeemed.

At step 502, the web server computes the number of credits of a user to be above a minimum threshold. The web server informs the user of the redeemable number of credits either by way of SMS, email, etc. At step 504, the web server receives the user response to redeem the credits. The user may be provided with different options against which the credits can be redeem. Such options include with limitation, a company's product/service, movies, music, televised events, presentations, books, or any other product or service. At step 506, the web server receives the user selection of the good/service for which the user wishes to redeem the credits. At step 508, the web server 14 confirms redemption by either arranging for delivery of the product or passing a voucher so that the selected service can be redeemed.

It should be noted that the teachings of the present disclosure can be applied individually or features of various embodiments described above may be combined together. Such variations are within the scope and spirit of the present disclosure. For example, in one embodiment, the web server may award credits to a user only on viewing, responding and commenting on the questions asked. In other embodiment, there may not be any minimum threshold for credits to be redeemed.

As evident, the teachings of the present disclosure find applications with corporates that would like to attract users to learn, become aware more and more about the company′ product/service offerings and al so be positively incentivized by way of redemption of their own products or services. The company gets visibility, advertises product promotion while delivering corporate social responsibility.

It will be appreciated that variations of the above disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method of communication with a user, the method comprising the steps of:
a. initiating a campaign, the initiation comprising sending a series of communications to the user;
b. awarding at least one credit to the user for each response received from the user relating to the series of communication;
c. maintaining a credit balance of the awarded at least one credit in a database; and
d. redeeming a quantity of credits by the user from the credit balance on successfully responding to at least one of one or more conditions, the one or more conditions correspond to the campaign.

2. The method of claim 1, further comprising the step of: storing the one or more conditions and the series of communications in the database.

3. The method of claim 1, further comprising the step of: providing the response instantaneously to a sponsor of the campaign.

4. The method of claim 1 further comprising the steps of: analyzing the response, and updating the user or a sponsor about the analyzed response instantaneously.

5. The method of claim 1 wherein the step of initiating comprises at least one of a group consisting of: sending a PUSH message, and displaying a webpage containing at least one of the series of communications.

6. The method of claim 1 wherein the response comprises viewing a website.

7. The method of claim 1 wherein the response comprises selecting an option from predefined options.

8. The method of claim 1 wherein the response comprises providing a feedback on a communication from the series of communication.

9. The method of claim 1 wherein the response comprises listening to at least one audio note.

10. The method of claim 1, wherein the step of maintaining comprises: adding said at least one credit to the credit balance in an account, said account being assigned to the user.

11. The method of claim 1, wherein the step of redeeming includes at least one of a group consisting of: obtaining access to a service and buying a product.

12. A system for communication with a user, said system comprising:
a web server being comprised of a means to initiate a campaign, wherein a series of communications are sent to the user; a means to award at least one credit to the user for each response received from the user relating to the series of communication, a means to maintain a credit balance of the awarded at least one credit in a database, and a means to redeem a quantity of credits from the credit balance on successfully responding to at least one of one or more conditions, the one or more conditions correspond to the campaign.

13. The system of claim 12, wherein the web server further comprises a means to store the one or more conditions and the series of communications in the database.

14. The system of claim 12, wherein the web server further comprises a means to provide the response instantaneously to a sponsor of the campaign.

15. The system of claim 12, wherein the web server further comprises a means to analyze the response and update the user or a sponsor about the analyzed response instantaneously.

16. The system of claim 12, wherein the web server further comprises at least one of a group consisting of: a means to send at least one PUSH message, and a means to display a webpage containing at least one of the series of communications.

17. The system of claim 12 wherein the response comprises viewing a website.

18. The system of claim 12 wherein the response comprises selecting an option from predefined options.

19. The system of claim 12 wherein the response comprises providing a feedback on a communication from the series of communication.

20. The system of claim 12 wherein the response comprises listening to at least one audio note.
